(19) United States
(12) Patent Application Publication
(10) Pub. No.: US 2004/0004180 A1
(43) Pub. Date: Jan. 8, 2004

(54) Sensor device

(76) Inventors: Neville John Freeman, Utkinton (GB); Gerard Anthony Ronan, Leslie Hough (GB); Paul Barraclough, Wythenshawe (GB); Marcus Swann, Leslie Hough (GB)

Correspondence Address: Transkbritt, PO Box 2550, Salt Lake City, UT, 84110, US

(21) Appl. No.: 10/343,072

(22) PCT Filed: Jul. 25, 2001
(86) PCT No.: PCT/GB01/03348

(30) Foreign Application Priority Data
Jul. 25, 2000 (GB) 0018156.0

(51) Int. Cl. G01J 1/04; G01J 5/08

(52) U.S. Cl. 250/227.14; 250/231.1

(57) ABSTRACT

The present invention relates to a sensor device and to a method for detecting the introduction of or changes in a chemical, biological or physical stimulus of interest in a localised environment, in particular to a sensor device and method for detecting the presence of or changes in chemical stimuli in a liquid or gas phase analyte (e.g. a microanalyte). The device compensates for fluctuations in the ambient environment.

The present invention relates to a sensor device and to a method for detecting the introduction of (eg the amount or concentration of) or changes in a chemical, biological or physical stimulus of interest in a localised environment, in particular to a sensor device and method for detecting the presence of or changes in chemical stimuli in a liquid or gas phase analyte (eg a microanalyte).

Conventional sensor devices for the detection of a chemical stimulus in an analyte (eg a microanalyte) frequently fail to provide the desired level of sensitivity and/or selectivity. Drawbacks are particularly apparent in for example biosensing applications where so-called nonspecific (ie undesirable background) events may mask the measured response of the sensor device to the analyte. In addition, for high precision applications, the temperature of the localised environment may become critical to the stability of the measurement. In addition small signals may be swamped by large changes in refractive index of the medium in the localised environment.

The present invention provides a sensor device adapted to compensate for non-specific events and tolerate fluctuations in the ambient environment (eg ambient temperature) by incorporating an optical “bridge” between two sensor components in intimate contact with an analyte. More particularly, the sensor device uses the optical properties of a specialised architecture incorporating the bridge to exhibit improved reliability, improved signal to noise ratio (sensitivity) and robustness.

Thus viewed from one aspect the present invention provides a sensor device for detecting the introduction of or changes in a stimulus (eg a chemical, physical or biological stimulus) of interest in a localised environment, said sensor device comprising:

a first sensor component including either (1) a sensing waveguide capable of exhibiting a measurable response to a change in the localised environment caused by the introduction of or changes in the stimulus of interest or (2) one or more sensing layers capable of inducing a measurable response to a change in the localised environment caused by the introduction of or changes in the stimulus of interest;

a second sensor component including either (1) an inactive (eg deactivated) waveguide substantially incapable of exhibiting a measurable response to a change in the localised environment caused by the introduction of or changes in the stimulus of interest or (2) one or more inactive (eg deactivated) layers substantially incapable of inducing a measurable response to a change in the localised environment caused by the introduction of or changes in the stimulus of interest;

wherein the sensor device is arranged so as to expose to the localised environment (1) at least a part of the (or each) sensing layer or the sensing waveguide of the first sensor component and (2) at least a part of the (or each) inactive layer or the inactive waveguide of the second sensor component.

By simultaneously exposing to the localised environment the first and second sensor components, the effect of thermal fluctuations and non-specific events (eg non-specific binding) may be compensated for (eg effectively cancelled out). This may be achieved by measuring the optical response of the first component relative to the optical response of the second component. In this way, the sensor device of the invention is tolerant to fluctuations in ambient conditions (eg ambient temperature) and capable of compensating for random physico-chemical events (unrelated to the stimulus of interest) thereby optimising the field of use.

Preferably the sensor device comprises: means for measuring the optical response (to the change in the localised environment caused by the introduction of or changes in the stimulus of interest) of the first sensor component relative to the optical response of the second sensor component.

The sensor device of the invention may be used to detect the introduction of or changes in a chemical, physical or biological stimulus. The interaction of the stimulus with the sensing waveguide or sensing layer may be a binding interaction or absorbance or any other interaction.

The sensor device of the invention is adapted to be usable in evanescent mode or whole waveguide mode. Generally speaking, it is known to make use of the evanescent field component of electromagnetic radiation incident on a waveguide structure (ie the field which extends outside the guiding region) to sense discrete changes in optical properties (see inter alia GB-A-2228082, U.S. Pat. No. 5,262,842, W0-A-97/12225 and GB-A-2307741). This method relies on “leakage” of optical signals from the waveguide structure into a sensing layer. The evanescent component of the optical signal being guided by the waveguide structure is typically small leading to limited interrogation of the sensing layer.

Thus in a first embodiment of the sensor device, the first sensor component includes one or more sensing layers capable of inducing in a secondary waveguide a measurable response to a change in the localised environment caused by the introduction of or changes in the stimulus of interest and the second sensor component includes one or more inactive layers substantially incapable of inducing in a secondary waveguide a measurable response to a change in the localised environment caused by the introduction of or changes in the stimulus of interest.

In this first embodiment the sensor device is advantageously adapted to optimise the evanescent component so as to induce in the secondary waveguide a measurable optical response. The first component may comprise a plurality of separate sensing layers to enable events at different localised environments to be detected.

To optimise the performance of the first embodiment, the physical, biological and chemical properties of the sensing layer and inactive layer are as similar as possible (with the exception of the response to the change in the localised environment caused by the introduction of or changes in the stimulus of interest). It is preferred that the secondary waveguide and inactive secondary waveguide have identical properties.

In a second embodiment of the invention, the first sensor component includes a sensing waveguide capable of exhibiting a measurable response to a change in the localised environment caused by the introduction of or changes in the stimulus of interest and the second sensor component includes a inactive waveguide substantially incapable of exhibiting a measurable response to a change in the localised environment caused by the introduction of or changes in the stimulus of interest.

In this second embodiment, the sensor device is adapted to minimise the evanescent component and may be used advantageously in a whole waveguide mode. The first sensor component may comprise a plurality of sensing waveguides each of which is laid down in a layered fashion.

To optimise-the performance of the second embodiment, the physical, biological and chemical properties of the sensing waveguide and inactive waveguide are as similar as possible (with the exception of the response to the change in the localised environment caused by the introduction of or changes in the stimulus of interest).

In a preferred sensor device of the invention, the sensing layer comprises an absorbent material (eg a polymeric material such as polysiloxane) or a bioactive material (eg containing antibodies, enzymes, DNA fragments, functional proteins or whole cells). The absorbent material may be capable of absorbing gases, liquids or vapours containing a chemical stimulus of interest. The bioactive material may be appropriate for liquid or gas phase biosensing.

In a preferred sensor device of the invention, the sensing waveguide comprises an absorbent material (eg a polymeric material such as polymethylmethacrylate, polysiloxane, poly-4-vinylpyridine) or a bioactive material (eg containing antibodies, enzymes, DNA fragments, functional proteins or whole cells). The sensing waveguide may comprise a porous silicon material optionally biofunctionalised with antibodies, enzymes, DNA fragments, functional proteins or whole cells.

As discussed above, the physical and chemical properties of the sensing layer/sensing waveguide are tailored so as to be as similar as possible to those of the inactive layer/inactive waveguide (with the exception of the response to the change in the localised environment caused by the introduction of or changes in the stimulus of interest). The following are examples of this general principle:

(1) where the sensing waveguide/sensing layer comprises a specific biofunctional material, the inactive waveguide/inactive layer may comprise the same bioactive material which has been made inactive (eg denatured for example thermally, photolytically or chemically)

(2) where the sensing waveguide/sensing layer comprises a certain optical isomer (eg a left handed isomer), the inactive waveguide/inactive layer may comprise the complimentary optical isomer (eg the right handed isomer). In this case, the left and right handed isomers may exhibit marked differences in response to a chemical or biological stimulus and so the system may be useful as a chemical sensor device or as a biosensor device

(3) where the sensing waveguide/sensing layer comprises an absorbent poly-4-vinylpyridine absorbent layer (hydrophillic), the inactive waveguide/inactive layer may comprise an absorbent polyisobutylene layer (hydrophobic). In this case, the stimuli of interest may be polar molecules such as water or alcohols.

In a preferred sensor device of the invention, the secondary waveguide comprises silicon oxynitride or silicon nitride. The inactive secondary waveguide may comprise silicon oxynitride of silicon nitride (so as to have identical properties to the secondary waveguide).

Where the first sensor component of the sensor device of the invention comprises a sensing waveguide adapted for use in whole waveguide mode, an absorbent layer in the form of an overcoating may be present for use as a membrane (for example) to separate out stimuli of interest.

Preferably the (or each) waveguide of the first and/or second sensor component is a planar waveguide (ie a waveguide which permits light propagation in any arbitrary direction within the plane). Preferably, the first and second sensor components of the sensor device of the invention constitute a multi-layered structure (eg a laminate structure). In this sense, the sensor device is simple to fabricate and fault tolerant in terms of construction errors. In a preferred embodiment, the plurality of layers in each of the first and second sensor component are built onto a substrate (eg composed of silicon) through known processes such as PECVD, LPCVD, etc. Such processes are highly repeatable and lead to accurate manufacture. Intermediate transparent layers may be added (eg silicon dioxide) if desired. Typically the first and second sensor component are multilayered structures of thickness in the range 0.2-10 microns.

The first and second sensor components may be integrated or discrete. For example, the first and second sensor components may be integrated onto a common substrate (a “back-to-back sensor”). In this embodiment, the localised environment surrounds the first and second sensor component (eg the sensor components may be typically immersed in a liquid or gas phase analyte) so as to expose to the analyte at least a part of the (or each) sensing layer or the sensing waveguide of the first component and at least a part of the (or each) inactive layer or the inactive waveguide of the second component. Alternatively for example, the first and second sensor components may be discretely built onto separate substrates (a “dual sensor”). In this embodiment, the localised environment constitutes a gap between the first and second sensor component which the analyte may fill so as to expose to the analyte at least a part of the (or each) sensing layer or the sensing waveguide of the first component and at least a part of the (or each) inactive layer or the inactive waveguide of the second component. For example, a spacer such as a microstructure may be positioned to provide a gap between the surfaces of the first and second sensor components. In certain cases, the surface tension in a liquid phase analyte may be sufficient to maintain the gap between the first and second sensor component. The gap is typically less than 10 microns.

The sensor device may comprise one or more means for intimately exposing to the localised environment at least a part of the (or each) sensing layer or the sensing waveguide and at least a part of the (or each) inactive layer or the inactive waveguide, said means being optionally integrated onto the first and/or second sensor component.

The one or more means for intimately exposing to the localised environment at least a part of the (or each) sensing layer or the sensing waveguide and at least a part of the (or each) inactive layer or the inactive waveguide (and any additional functionality) may be provided in a microstructure positionable on the surface of and in intimate contact with the first and/or second sensor component. Preferably the microstructure comprises means for intimately exposing to the localised environment at least a part of the (or each) sensing layer or the sensing waveguide and at least a part of the (or each) inactive layer or the inactive waveguide in the form of one or more microchannels and/or microchambers into which chemicals may be fed (or chemical reactions may take place).

In a preferred embodiment, the means for intimately exposing to the localised environment at least a part of the (or each) sensing layer or the sensing waveguide and at least a part of the (or each) inactive layer or the inactive waveguide is included in a cladding layer. For example, microchannels and/or microchambers may be etched into the cladding layer. The cladding layer may perform optical functions such as preventing significant discontinuities at the boundary of the sensing waveguide or chemical functions such as restricting access of species to the sensing waveguide. The cladding layer may be integrated onto the first and/or second sensor component.

Preferably, the whole of or a portion of any additional functionality may be included in the cladding layer. Additionally, the sensing layer may be incorporated in the cladding layer in the form of an absorbent material. Particularly preferably, the whole additional functionality may be provided in the cladding layer and include devices such as for example quadrature electric field tracks or other microfluidic devices.

The sensor device of the invention may advantageously be used to detect the presence of or changes in a chemical stimuli in an analyte which is introduced into the sensor device (ie a chemical sensor device). For example, a gaseous or liquid phase analyte comprising chemical stimuli may be introduced into the sensor device. Alternatively, a chemical reaction may take place which effects changes in the nature of the chemical stimuli in situ and causes a change in the localised environment.

The sensor device of the invention may be used to measure inter alia pressure, position, temperature or vibration in relation to the presence of or changes in a physical stimulus (ie a physical sensor device). The physical stimulus may be applied to the sensing layer or sensing waveguide of the first sensor component via an impeller (for example) located on the sensing layer or sensing waveguide to enable the measurement of (for example) pressure or precise position.

As a consequence of the introduction of or changes in a physical, biological and/or chemical stimulus in the localised environment (ie a change in the refractive index of material in the localised environment), changes in the dielectric properties (eg the effective refractive index) of the sensing waveguide or sensing layer occur. This causes a measurable optical response (ie a change in the transmission of electromagnetic radiation down the sensing waveguide (or waveguides) in whole waveguide mode or the secondary waveguide in evanescent field mode). For example, changes in the refractive index of material in the localised environment might occur as a consequence of a chemical reaction.

An interference pattern may be generated when the electromagnetic radiation from the sensor component is coupled into free space and the pattern may be recorded in a conventional manner (see for example WO-A-98/22807). In this embodiment, a measurable optical response of the sensor component to a change in the localised environment manifests itself as movement of the fringes in the interference pattern. The phase shift of the radiation in the sensor component (eg induced in the secondary waveguide in evanescent field mode or exhibited in the sensing waveguide in whole waveguide mode) may be calculated from the movement in the fringes. In turn, the amount of or changes in a chemical, biological or physical stimulus in the localised environment may be calculated from the phase shift.

Electromagnetic radiation generated from a conventional source may be propagated into the first and second sensor component in a number of ways. In the preferred embodiment, radiation is simply input via an end face of the sensor component (this is sometimes described as “an end firing procedure”). Preferably (but not essentially), the electromagnetic radiation source provides incident electromagnetic radiation having a wavelength falling within the visible range. Preferably the sensor device comprises: propagating means for substantially simultaneously propagating incident electromagnetic radiation into the first and second sensor components. Typically the same amount of radiation is propagated into each of the first and second sensor components. For example, one or more coupling gratings or mirrors may be used. A tapered end coupler rather than a coupling grating or mirror may be used to propagate light into the lowermost waveguide.

The incident electromagnetic radiation may be oriented (eg plane polarised) as desired using an appropriate polarising means. The incident electromagnetic radiation may be focussed if desired using a lens or similar micro-focussing means.

Using electromagnetic radiation of different frequencies (either simultaneously or sequentially) may vary the contribution of the sensor components and may further enhance the utility of the device.

Multimode excitation may provide useful additional information. By comparing the outer and inner areas of the interference pattern, it may be possible to determine the extent to which any refractive index change has been induced by changes in the thickness of the outer regions (eg the absorbing layer) and the degree to which it has been effected by physico-chemical changes in the inner regions.

Both the TE (transverse electric) and the TM (transverse magnetic) excitation modes may be used sequentially or simultaneously to interrogate the sensor device as described for example in WO-A-01/36946 (Farfield Sensors Limited). In this sense, the sensor device comprises: first irradiating means for irradiating the sensor components with TM mode electromagnetic radiation and second irradiating means for irradiating the first and second sensor components with TE mode electromagnetic radiation. The relative phase changes of the two modes are used to identify and quantify the nature of the optical changes taking place in the sensing layer or sensing waveguide. For example, it may be possible to attribute changes in the effective refractive index of the sensing layer or sensing waveguide to specific changes in dimension (eg expansion or contraction) and/or composition. The relative phase changes of the two modes may also be used to identify such changes taking place in subsequent layers when more compact structures are employed. Conveniently, measurement of capacitance and refractive mode index of the two modes yields further information on changes occurring in the absorbent layer.

Transverse electric and transverse magnetic phase shifts may be compared sequentially or simultaneously in order to resolve effective thickness changes from changes in the effective refractive index in realtime on the sensor device.

Electromagnetic radiation may be modulated (amplitude, frequency or phase for example) to provide additional information on the behaviour of the sensor device.

The first sensor component may be excited across its width and a two-dimensional photodiode array (or the like) may be used to effectively interrogate “strips” of the sensor (eg an array sensor). This may be carried out across more than one axis simultaneously or sequentially to provide spatially resolved information relating to events on the surface of the first sensor component.

The sensor components may be optionally perturbed (eg thermally perturbed) to enable the sensor device to be biased. This enables the precise degree of optical response (eg phase shift) caused by the chemical or physical stimulus to be determined.

Movement in the interference fringes may be measured either using a single detector which measures changes in the electromagnetic radiation intensity or a plurality of such detectors which monitor the change occurring in a number of fringes or the entire interference pattern. The one or more detectors may comprise one or more photodetectors. Where more than one photodetector is used this may be arranged in an array.

In an embodiment of the device, the electromagnetic radiation source and one or more detectors are integrated with the device into a single assembly.

A plurality of electromagnetic radiation detector units (eg in an array) and/or a plurality of electromagnetic radiation sources may be used to measure in discrete areas of the first sensor component simultaneously the responses to changes in the localised environment. Alternatively, the position of the electromagnetic radiation detector and electromagnetic radiation source relative to the sensor component may be changed to provide information concerning responses in discrete areas of the first sensor component. For example, discrete responses to a change in the localised environment caused by the presence of the same or different stimuli may be measured in discrete areas of the first sensor component. In the first instance, concentration gradients of the same stimulus may be deduced. In the second instance, discrete responses in different regions to changes in the localised environment may be measured. For this purpose, the preferred device makes use of the versatility of the evanescent mode and comprises a plurality of separate sensing layers or regions.

Conveniently, electrodes positioned in contact with a surface of the sensing layer or sensing waveguide enable capacitance to be measured simultaneously. The electrodes may take the form of either parallel plates laid alongside the plurality of planar waveguides or as an interdigitated or meander system laid down on the top and bottom surfaces of the sensing waveguide or sensing layer or adjacent to it. In the case of a meander system, the metal forming the electrode is responsible for absorbing excessive amounts of light and as such the capacitance is measured on an adjacent structure which is not utilised for optical measurement.

Viewed from a further aspect the present invention provides a method for detecting the introduction of (eg the amount or concentration of) or changes in a chemical, biological or physical stimulus of interest in a localised environment, said method comprising:

providing a sensor device as hereinbefore defined;

introducing or causing changes in the chemical, biological or physical stimulus of interest in the localised environment;

irradiating simultaneously the first and second sensor component with electromagnetic radiation;

measuring a relative optical response being the optical response of the first sensor component relative to the second sensor component; and

relating the relative optical response to the presence of or changes in the chemical, biological or physical stimulus of interest.

Preferably the method of the invention comprises:

measuring movements in the interference pattern; and

relating the movements to the presence of or changes in the chemical, biological or physical stimulus of interest.

Preferably the method of the invention comprises: measuring a plurality of discrete responses in different regions of the first sensor component.

Preferably the method of the invention is carried out in evanescent or whole waveguide mode. Preferably multiple irradiation sources and/or multiple detectors are used.

In a preferred embodiment, the method comprises: continuously introducing the analyte containing a chemical stimulus of interest. In a particularly preferred embodiment, the method comprises: continuously introducing the analyte containing a chemical stimulus of interest in a discontinuous flow (eg as a train of discrete portions).

Preferably the method further comprises: inducing a chemical reaction in the analyte which is static in the localised environment.

Preferably the method further comprises: calculating the phase shift from the movements in the interference pattern and relating the phase shift to the amount (eg concentration) of or changes in the chemical stimulus of interest. Methods for performing this calculation will be familiar to those skilled in the art. The phase shift data may be related to the amount (eg concentration) of or changes in the chemical stimulus of interest by comparison with standard calibration data.

Viewed from a yet further aspect the present invention provides an apparatus comprising a plurality of sensor devices as hereinbefore defined arranged in an array.

Viewed from an even still further aspect of the present invention there is provided the use of a sensor device according to the first aspect of the invention for detecting the presence of or changes in a chemical, biological or physical stimulus of interest in a localised environment.

Viewed from a yet still further aspect the present invention provides a kit of parts comprising:

a sensor device as hereinbefore defined, an electromagnetic radiation source capable of simultaneous irradiation of the first sensor component and second sensor component and one or more detectors in an array. The kit of the invention can be easily assembled in a robust and fault tolerant manner.

The term “optical” used hereinbefore means radiation of any wavelength in the electromagnetic spectrum or the selective absence of such radiation (as in obscuration devices).

The invention will now be described in a non-limitative sense with reference to the accompanying Figures in which:

FIG. 1 represents a schematic illustration of a sensor device in accordance with an embodiment of the invention (whole waveguide mode);

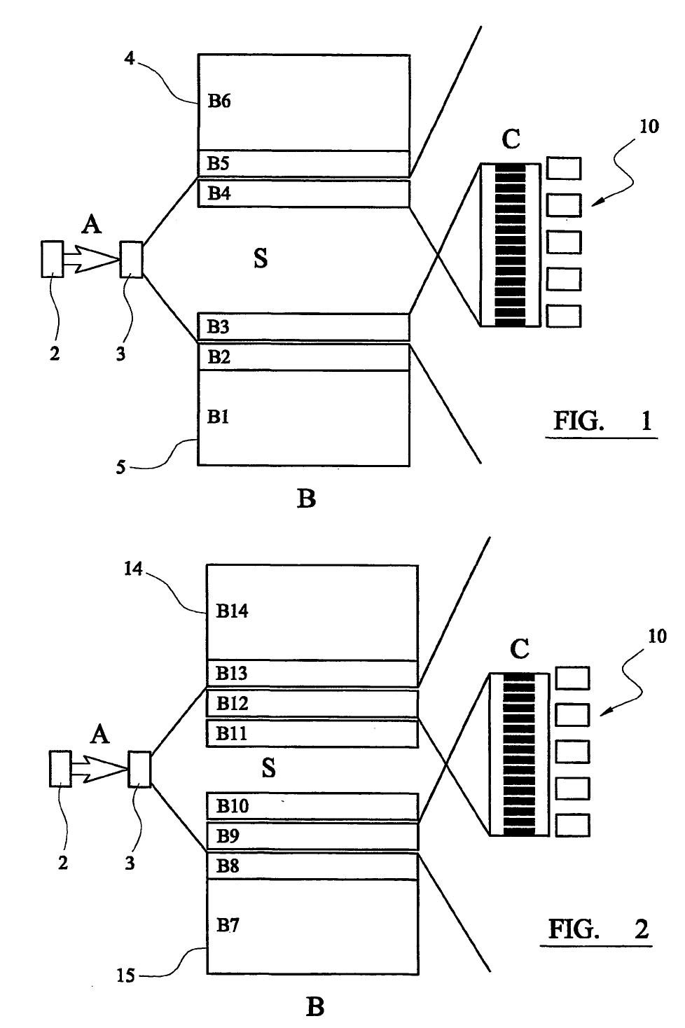

FIG. 2 represents a schematic illustration of a biosensor device of an embodiment of the invention (evanescent field mode);

FIG. 3 represents a schematic illustration of a sensor device of the invention in back to back configuration (whole waveguide mode); and

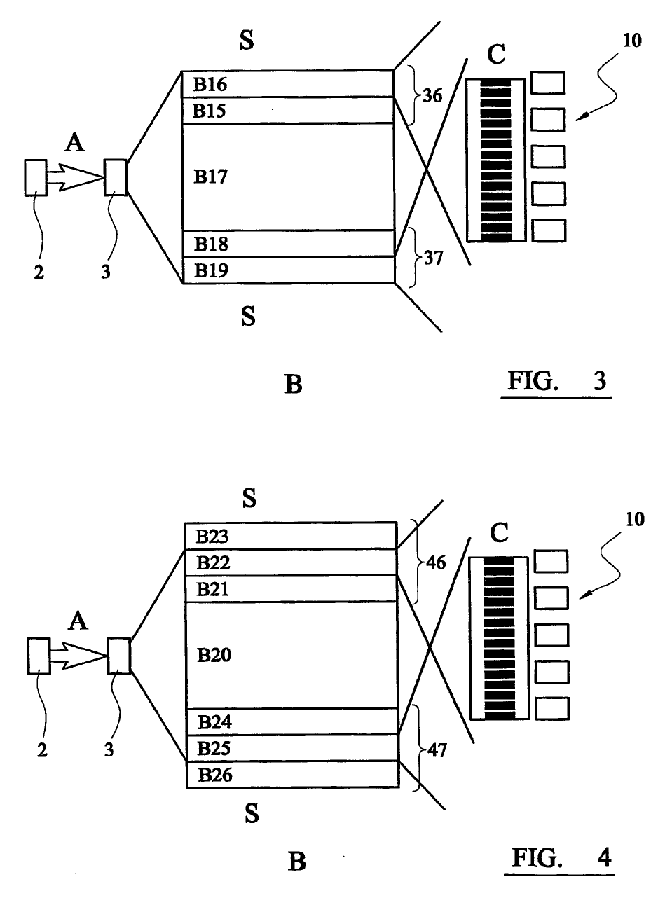

FIG. 4 represents a schematic illustration of a biosensor device of an embodiment of the invention in back to back configuration (evanescent field mode).

A whole waveguide sensor device B of the invention is illustrated schematically in FIG. 1. It is of the dual sensor type and may be used for detecting the presence of polar molecules in an analyte S (eg the presence of water, an alcohol, ammonia, etc).

The analyte S is introduced into the gap (typically of the order of 10 microns or less) between a first and a second sensor component 5 and 4 of the sensor device B. The first sensor component 5 comprises a silicon dioxide layer B2 and a sensing waveguide B3 fabricated on a silicon substrate B1. The sensing waveguide B3 is an absorbent polymer poly-4-vinylpyridine (P4VP) which is hydrophillic. The second sensor component 4 comprises a silicon dioxide layer B5 and an inactive waveguide B4 fabricated on a silicon substrate B6. The inactive waveguide B4 is an absorbent polymer polyisobutylene which is hydrophobic.

The analyte S is introduced into the sensor B in the gap between the first and second sensor components 5 and 4 so as to expose at least a part of the sensing waveguide B3 and at least a part of the inactive waveguide B4 to the analyte S. The purpose of the inactive waveguide B4 is to respond to non-specific events in an essentially identical manner to the sensing waveguide B3 but not to respond to polar molecules. For example, both polymers swell to a similar degree in response to temperature fluctuations but only P4VP binds to polar molecules.

Plane polarised electromagnetic radiation (A) is generated by an electromagnetic source (not shown) and is focussed using a lens 2 and orientated using a polariser 3. The radiation A passes into the first and second sensor components 5 and 4 of the sensor device B ie into the sensing waveguide B3 and the inactive waveguide B4 simultaneously such that the level of radiation entering the inactive waveguide B4 is approximately the same as that entering the sensing waveguide layer B3.

Having passed down the sensor structure, the electromagnetic radiation is coupled into free space generating an interference pattern C recorded using a photodetector array 10. The interference pattern C is used to determine the relative phase shift exhibited by the sensing waveguide B3 when compared to the inactive waveguide B4. The relative phase shift is directly proportional to changes occurring in the material of the sensing waveguide B3 caused by interaction with polar molecules in the analyte S.

The interferometric sensor device illustrated in evanescent field mode in FIG. 2 is a biosensor device of the invention. It is of the dual biosensor type and may be used (for example) to detect the presence of hCG in an analyte S (eg a blood or urine sample).

The analyte S (eg blood or urine) is introduced into the gap between a first and a second sensor component 15 and 14 of the sensor device B. The first sensor component 15 comprises a silicon dioxide layer B8 and a silicon oxynitride (or silicon nitride) secondary waveguide B9 fabricated on a silicon substrate B7. The evanescent component of the secondary waveguide B9 probes a sensing layer B10 and changes in the refractive index of the sensing layer B10 effect the transmission of radiation through the secondary waveguide B9. The sensing layer B10 in this embodiment comprises a biotin/avidin functionalised surface treated with protein G and anti-hCG. The second sensor component 14 comprises a silicon dioxide layer B13 and a silicon oxynitride (or silicon nitride) inactive waveguide B12 fabricated on a silicon substrate B14. Adjacent to the inactive waveguide B12 is an inactive layer B11. The inactive layer B11 comprises a biotin/avidin functionalised surface treated with protein G and anti-hCG which has been heat denatured.

The analyte S (eg blood) is introduced into the sensor B in the gap between the first and second sensor components 15 and 14 so as to expose at least a part of the sensing layer B10 and at least a part of the inactive layer B11 to the analyte S. The purpose of the inactive layer B11 is to respond to non-specific events in an essentially identical manner to the sensing layer B10 but not to respond to hCG.

Plane polarised electromagnetic radiation (A) is generated by an electromagnetic source (not shown) and is focussed using a lens 2 and orientated using a polariser 3. The radiation A passes into the first and second sensor components 15 and 14 of the sensor device B, in particular into the secondary waveguide B9 and the inactive waveguide B12 simultaneously such that the level of radiation entering the inactive waveguide B12 is approximately the same as that entering the secondary waveguide B9.

Having passed down the sensor structure, the electromagnetic radiation is coupled into free space generating an interference pattern C recorded using a photodetector array 10. The interference pattern C is used to determine the relative phase shift induced in the secondary waveguide B9 when compared to the inactive waveguide B12. The relative phase shift is directly proportional to changes occurring in the material of the sensing layer B10 caused by interaction with the analyte S.

The whole waveguide sensor device illustrated schematically in FIG. 3 is of the back-to-back type (but in all other respects is the same as the sensor device of FIG. 1).

In sensor B, first and second sensor components 36 and 37 are integrally fabricated on opposite faces of a silicon substrate B17. The first sensor component 37 comprises a silicon dioxide layer B18 and an inactive waveguide B19. The second sensor component 36 comprises a silicon dioxide layer B15 and a sensing waveguide B16. The sensing waveguide B16 is an absorbent polymer poly-4-vinylpyridine (P4VP) which is hydrophillic. The inactive waveguide B19 is an absorbent polymer polyisobutylene which is hydrophobic.

The sensor device B of this embodiment is arranged so as to expose at least a part of the sensing waveguide B16 and at least a part of the inactive waveguide B19 to the analyte S by immersing the first and second sensor components 36 and 37 in the analyte S. The purpose of the inactive waveguide B19 is to respond to non-specific events in an essentially identical manner to the sensing waveguide B16 but not to respond to polar molecules. For example, both polymers swell to a similar degree in response to temperature fluctuations but only P4VP binds to polar molecules.

Plane polarised electromagnetic radiation (A) is generated by an electromagnetic source (not shown) and is focussed using a lens 2 and orientated using a polariser 3. The radiation A passes into the first and second sensor components 36 and 37 of the sensor device B ie into the sensing waveguide B16 and the inactive waveguide B19 simultaneously such that the level of radiation entering the inactive waveguide B16 is approximately the same as that entering the sensing waveguide layer B19.

Having passed down the sensor structure, the electromagnetic radiation is coupled into free space generating an interference pattern C recorded using a photodetector array 10. The interference pattern C is used to determine the relative phase shift exhibited by the sensing waveguide B16 when compared to the inactive waveguide B19. The relative phase shift is directly proportional to changes occurring in the material of the sensing waveguide B16 caused by interaction with polar molecules in the analyte S.

The interferometric biosensor device illustrated in evanescent field mode in the FIG. 4 is of the back-to-back type (but in all other respects is the same as the biosensor device of FIG. 2).

In sensor B, first and second sensor components 46 and 47 are integrally fabricated on opposite faces of a silicon substrate B20. The first sensor component 46 comprises a silicon dioxide layer B21 and a silicon oxynitride (or silicon nitride) secondary waveguide B22. The evanescent component of the secondary waveguide B22 probes a sensing layer B23 and changes in the refractive index of the sensing layer B23 effect the transmission of radiation through the secondary waveguide B22. The sensing layer B23 in this embodiment comprises a biotin/avidin functionalised surface treated with protein G and anti-hCG.

The second sensor component 47 comprises a silicon dioxide layer B24 and a silicon oxynitride (or silicon nitride) inactive waveguide B25. Adjacent to the inactive waveguide B25 is an inactive layer B26. The inactive layer B26 comprises a biotin/avidin functionalised surface treated with protein G and anti-hCG which has been heat denatured.

The biosensor device of this embodiment is arranged so as to expose at least a part of the sensing layer B23 and at least a part of the inactive layer B26 to the analyte S by immersing the first and second sensor components 46 and 47 in the analyte S. The purpose of the inactive layer B26 is to respond to non-specific events in an essentially identical manner to the sensing layer B23 but not to respond to hCG.

Plane polarised electromagnetic radiation (A) is generated by an electromagnetic source (not shown) and is focussed using a lens 2 and orientated using a polariser 3. The radiation A passes into the first and second sensor components 46 and 47 of the sensor device B, in particular into the secondary waveguide B22 and the inactive waveguide B25 simultaneously such that the level of radiation entering the inactive waveguide B22 is approximately the same as that entering the secondary waveguide B25.

Having passed down the sensor structure, the electromagnetic radiation is coupled into free space generating an interference pattern C recorded using a photodetector array 10. The interference pattern C is used to determine the relative phase shift induced in the secondary waveguide B22 when compared to the inactive waveguide B25. The relative phase shift is directly proportional to changes occurring in the material of the sensing layer B23 caused by interaction with the analyte S.

1. A sensor device for detecting the introduction of or changes in a stimulus of interest in a localised environment, said sensor device comprising:
a first sensor component including either (1) a sensing waveguide capable of exhibiting a measurable response to a change in the localised environment caused by the introduction of or changes in the stimulus of interest or (2) one or more sensing layers capable of inducing a measurable response to a change in the localised environment caused by the introduction of or changes in the stimulus of interest;
a second sensor component including either (1) an inactive waveguide substantially incapable of exhibiting a measurable response to a change in the localised environment caused by the introduction of or changes in the stimulus of interest or (2) one or more inactive layers substantially incapable of inducing a measurable response to a change in the localised environment caused by the introduction of or changes in the stimulus of interest;
wherein the sensor device is arranged so as to expose to the localised environment (1) at least a part of the (or each) sensing layer or the sensing waveguide of the first sensor component and (2) at least a part of the (or each) inactive layer or the inactive waveguide of the second sensor component.

2. A sensor device as claimed in claim 1 further comprising: means for measuring an optical response of the first sensor component relative to an optical response of the second sensor component.

3. A sensor device as claimed in claim 1 or 2 adapted to be usable in evanescent mode or whole waveguide mode.

4. A sensor device as claimed in any preceding claim wherein the first sensor component includes:
one or more sensing layers capable of inducing in a first secondary waveguide a measurable response to a change in the localised environment caused by the introduction of or changes in the stimulus of interest,
and the second sensor component includes:
one or more inactive layers substantially incapable of inducing in a second secondary waveguide a measurable response to a change in the localised environment caused by the introduction of or changes in the stimulus of interest.

5. A sensor device as claimed in claim 4 wherein the physical, biological and chemical properties of the (or each) sensing layer and the (or each) inactive layer are substantially identical with the exception of the response to the change in the localised environment caused by the introduction of or changes in the stimulus of interest.

6. A sensor device as claimed in claim 4 or 5 wherein the first secondary waveguide and second secondary waveguide have identical properties.

7. A sensor device as claimed in any of claims 4, 5 or 6 wherein the sensing layer comprises an absorbent material or a bioactive material.

8. A sensor device as claimed in claim 7 wherein the absorbent material is capable of absorbing gases,-liquids or vapours containing a chemical stimulus of interest.

9. A sensor device as claimed in claim 7 or 8 wherein the absorbent material is polymeric.

10. A sensor device as claimed in claim 7, 8 or 9 wherein the absorbent material is polysiloxane.

11. A sensor device as claimed in claim 7 wherein the bioactive material contains antibodies, enzymes, DNA fragments, functional proteins or whole cells.

12. A sensor device as claimed in any of claims 1 to 3 wherein the first sensor component includes:
a sensing waveguide capable of exhibiting a measurable response to a change in the localised environment caused by the introduction of or changes in the stimulus of interest,
and the second sensor component includes:
an inactive waveguide substantially incapable of exhibiting a measurable response to a change in the localised environment caused by the introduction of or changes in the stimulus of interest.

13. A sensor device as claimed in claim 12 wherein the physical, biological and chemical properties of the sensing waveguide and inactive waveguide are substantially identical with the exception of the response to the change in the localised environment caused by the introduction of or changes in the stimulus of interest.

14. A sensor device as claimed in claim 12 or 13 wherein the sensing waveguide comprises an absorbent material or a bioactive material.

15. A sensor device as claimed in claim 14 wherein the sensing waveguide comprises a porous silicon material optionally biofunctionalised with antibodies, enzymes, DNA fragments, functional proteins or whole cells.

16. A sensor device as claimed in claim 14 or 15 wherein the absorbent material is polymeric.

17. A sensor device as claimed in any of claims 14, 15 or 16 wherein the absorbent material is polymethylmethacrylate, polysiloxane or poly-4-vinylpyridine.

18. A sensor device as claimed in claim 14 wherein the bioactive material contains antibodies, enzymes, DNA fragments, functional proteins or whole cells.

19. A sensor device as claimed in claim 1 wherein the sensing waveguide/sensing layer comprises a bioactive material and the inactive waveguide/inactive layer comprises the same bioactive material which has been made inactive.

20. A sensor device as claimed in claim 19 wherein the bioactive material has been made inactive by denaturing.

21. A sensor device as claimed in claim 19 or 20 wherein the bioactive material has been made inactive thermally, photolytically or chemically.

22. A sensor device as claimed in claim 1 wherein the sensing waveguide/sensing layer comprises a first optical isomer and the inactive waveguide/inactive layer comprises a second optical isomer, wherein the first optical isomer is complementary to the second optical isomer.

23. A sensor device as claimed in claim 1 wherein one of the sensing waveguide/sensing layer or the inactive waveguide/inactive layer comprises a hydrophillic layer and the other comprises a hydrophobic layer.

24. A sensor device as claimed in claim 23 wherein one of the sensing waveguide/sensing layer or the inactive waveguide/inactive layer comprises an absorbent poly-4-vinylpyridine layer and the other comprises an absorbent polyisobutylene layer.

25. A sensor device as claimed in any preceding claim wherein each waveguide of the first and/or second sensor component is a planar waveguide.

26. A sensor device as claimed in claim 25 wherein each of the first and second sensor components constitute a multilayered structure.

27. A sensor device as claimed in claim 26 wherein each of the first and second sensor components constitute a laminate structure.

28. A sensor device as claimed in any preceding claim wherein the first and second sensor components may be integrated onto a common substrate whereby the localised environment surrounds the first and second sensor component so as to expose to the stimulus of interest at least a part of the (or each) sensing layer or the sensing waveguide of the first sensor component and at least a part of the (or each) inactive layer or the inactive waveguide of the second sensor component.

29. A sensor device as claimed in any of claims 1 to 27 wherein the first and second sensor components may be discretely built onto separate substrates whereby the localised environment constitutes a gap between the first and second sensor component into which the stimulus of interest is introduced so as to expose to the stimulus of interest at least a part of the (or each) sensing layer or the sensing waveguide of the first sensor component and at least a part of the (or each) inactive layer or the inactive waveguide of the second sensor component.

30. A sensor device as claimed in claim 27 or 29 wherein the first sensor component consists essentially of a sensing waveguide and optionally at least one silicon dioxide layer fabricated onto a first silicon substrate and the second sensor component consists essentially of an inactive waveguide and optionally at least one silicon dioxide layer fabricated onto a second silicon substrate.

31. A sensor device as claimed in claim 27 or 28 wherein the first and second sensor component are integrally fabricated on opposite faces of a silicon substrate, the first sensor component consisting essentially of a sensing waveguide and optionally at least one silicon dioxide layer and the second sensor component consisting essentially of an inactive waveguide and optionally at least one silicon dioxide layer.

32. A sensor device as claimed in claim 30 or 31 wherein
(1) the sensing waveguide and inactive waveguide are adapted to swell to a substantially identical degree in response to a temperature fluctuation;
(2) the sensing waveguide is adapted to swell in the presence of the stimulus of interest; and
(3) the inactive waveguide is adapted not to swell in the presence of the stimulus of interest.

33. A sensor device as claimed in claim 27 or 29 wherein the first sensor component is fabricated onto a first silicon substrate and consists essentially of a sensing layer in intimate contact with a first secondary waveguide and optionally at least one silicon dioxide layer and the second sensor component is fabricated onto a second silicon substrate and consists essentially of an inactive layer in intimate contact with an second secondary waveguide and optionally at least one silicon dioxide layer.

34. A sensor device as claimed in claim 27 or 28 wherein the first and second sensor component are fabricated onto a common silicon substrate, the first sensor component consists essentially of a sensing layer in intimate contact with a first secondary waveguide and optionally at least one silicon dioxide layer and the second sensor component consists essentially of an inactive layer in intimate contact with a second secondary waveguide and optionally at least one silicon dioxide layer.

35. A sensor device as claimed in claim 33 or 34 wherein the sensing layer is a biotin/avidin functionalised layer treated with protein G and anti-hCG and the inactive layer is a biotin/avidin functionalised surface treated with protein G and anti-hCG which has been denatured.

36. A method for detecting the introduction of or changes in a chemical, biological or physical stimulus of interest in a localised environment, said method comprising:
providing a sensor device as defined in any preceding claim;
introducing or causing changes in the chemical, biological or physical stimulus of interest in the localised environment;
irradiating simultaneously the first and second sensor component with electromagnetic radiation;
measuring a relative optical response being the optical response of the first sensor component relative to the second sensor component; and
relating the relative optical response to the presence of or changes in the chemical, biological or physical stimulus of interest.

37. A method as claimed in claim 36 wherein the relative optical response is movements in an interference pattern.

38. A method as claimed in claim 36 or 37 comprising:
continuously introducing an analyte containing a chemical stimulus of interest into the localised environment.

39. A method as claimed in claim 38 comprising: continuously introducing the analyte in a discontinuous flow.

40. A method as claimed in any of claims 36 to 39 comprising: inducing a chemical reaction in an analyte containing a chemical stimulus of interest which is static in the localised environment.

41. A method as claimed in any of claims 37 to 40 comprising:
calculating the phase shift from the movements in the interference pattern and relating the phase shift to the amount of or changes in the stimulus of interest.
